(19) United States
(12) Patent Application Publication
(10) Pub. No.: US 2023/0009663 A1
(43) Pub. Date: Jan. 12, 2023

(54) METHOD FOR DELEGATING DEVICE OWNERSHIP BASED ON BLOCKCHAIN

(71) Applicants: ELECTRONICS AND TELECOMMUNICATIONS RESEARCH INSTITUTE, Daejeon (KR); Anyang Univ. Academy-industry Cooperation Foundation, Anyang-si (KR)

(72) Inventors: Yun Chul CHOI, Daejeon (KR); Jung Soo PARK, Daejeon (KR); Euihyun JUNG, Daejeon (KR)

(21) Appl. No.: 17/859,064

(22) Filed: Jul. 7, 2022

(30) Foreign Application Priority Data
Jul. 8, 2021 (KR) 10-2021-0089447

(51) Int. Cl. G06Q 20/38

(52) U.S. Cl. CPC G06Q 20/389

(57) ABSTRACT

Provided is a method for delegating a device ownership based on a blockchain. The blockchain-based device ownership delegating method may include: transferring a device ownership request of a first user to a blockchain; providing a smart contract based ownership request event generated by the blockchain to a second user; transferring a device ownership change request of the second user to the blockchain; providing a smart contract based ownership change event generated by the blockchain to a device decentralized application (DApp); changing a device ownership; and recording a change history of the device ownership in the blockchain.

### CROSS-REFERENCE TO RELATED APPLICATION

This application claims priority to and the benefit of Korean Patent Application No. 10-2021-0089447 filed in the Korean Intellectual Property Office on Jul. 8, 2021, the entire contents of which are incorporated herein by reference.

### BACKGROUND OF THE INVENTION

### 1. Field of the Invention

The present disclosure relates to a method for delegating a device ownership based on a blockchain.

### 2. Description of Related Art

As a cooperation structure of various service areas increases today, seamless transparent service interlocking between respective service areas is required. To this end, access control for physical and virtual resources of a device should be possible. For example, when a user drives a smart car and parks the smart car in a smart parking lot, the user should have driving permissions for smart cars in a smart car service area, and at the same time, the user needs to have an entry authority for the smart parking lot in a smart parking lot service area. A most basic structure in the access control is the transfer of an ownership of the device.

Meanwhile, self-sovereign identification (or self-sovereign identity) technology has recently attracted attention. The existing personal identification is dependent on a specific site or service, and is implemented in a form that creates an account in an authentication server responsible for the service area for the use of a predetermined service, and is granted authority to the account. Such a form does not have a problem when authority processing in a single service area is performed. However, if the user uses multiple service areas, the account should be generated separately for all the service areas which the user wants to use, and an authentication procedure should be carried out every time the user moves the service area. Due to such a silo structure, the user should remember and manage dozens to hundreds of accounts, and the risk of leaking personal information is also very high.

The self-sovereignty identification is a concept that a user other than another information processing person directly possesses and manages information on the user may be to return an information use authority and a control authority to an information object Contrary to the traditional approach, the self-sovereign identification model focuses on realizing personal information protection, and which allows individuals to perfectly control and manage identity data on behalf of centralized agencies, so it is not necessary to store authentication information in various services and it is possible to significantly enhance personal information protection and use convenience.

A blockchain using a distributed ledger is technology that may satisfy properties such as ‘transparency’ that all systems and algorithms should be transparent to users, ‘persistence’ that user's personal information should be stored for a long time, and ‘compatibility’ that user's personal information should be compatible, and in recent years, a research into the self-sovereign identification technology to which the blockchain is applied has been actively conducted.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to provide a method for delegating an ownership of a device based on a blockchain, which can distribute and store, and delegate the ownership of the device by using a decentralized identifier (DID) of a blockchain based self-sovereign identification model.

An example embodiment of the present disclosure provides a method for delegating a device ownership based on a blockchain, which may include: transferring a device ownership request of a first user to a blockchain; providing a smart contract based ownership request event generated by the blockchain to a second user; transferring a device ownership change request of the second user to the blockchain; providing a smart contract based ownership change event generated by the blockchain to a device decentralized application (DApp); changing a device ownership; and recording a change history of the device ownership in the blockchain.

In some example embodiments of the present disclosure, the method may further include generating a first user DApp according to a user registration request of the first user.

In some example embodiments of the present disclosure, the transferring of the device ownership request to the blockchain may include transmitting, to the blockchain, the device ownership request received from the first user by using the first user DApp.

In some example embodiments of the present disclosure, the method may further include generating a second user DApp according to the user registration request of the second user.

In some example embodiments of the present disclosure, the providing of the smart contract based ownership request event generated by the blockchain to the second user may include providing, to the second user, the smart contract based ownership request event received from the blockchain by using the second user DApp.

In some example embodiments of the present disclosure, the transferring of the device ownership change request to the blockchain may include transmitting, to the blockchain, the device ownership change request received from the second user by using the second user DApp.

In some example embodiments of the present disclosure, the second user DApp may be generated in response to the user registration request of the second user.

In some example embodiments of the present disclosure, the device DApp may be generated in response to a device registration request of a device owner.

In some example embodiments of the present disclosure, the method may further include receiving a change notification of the device ownership from the blockchain, and providing the received change notification to the first user and the second user.

In some example embodiments of the present disclosure, the device ownership may be stored by using a decentralized identifier (DID).

Another example embodiment of the present disclosure provides a method for delegating a device ownership based on a blockchain, which may include: generating a first user decentralized application (DApp) according to a user registration request of the first user; generating a device DApp according to a device registration request of the first user; transmitting, to a blockchain, the device ownership request received from the first user by using the first user DApp; generating a second user DApp according to a user registration request of the second user; transmitting, to the blockchain, a device ownership change request received from the second user by using the second user DApp; changing a device ownership by using the device DApp; and recording a change history of the device ownership in the blockchain by using the device DApp.

In some example embodiments of the present disclosure, the generating of the first user DApp may include confirming duplication by using a user and device database, and generating the first user DApp and a key when the duplication does not occur.

In some example embodiments of the present disclosure, the method may further include: transmitting the first user DApp and the key to the blockchain, and being returned with a transaction from the blockchain; and storing a private key used for the transaction and the first user DApp in the user and the device database.

In some example embodiments of the present disclosure, the generating of the device DApp may include confirming duplication by using a user and device database, and generating the device DApp and the key when the duplication does not occur.

In some example embodiments of the present disclosure, the method may further include: transmitting the device DApp and the key to the blockchain, and being returned with the transaction from the blockchain; and storing the private key used for the transaction and the device DApp in the user and the device database.

In some example embodiments of the present disclosure, the generating of the second user DApp may include confirming duplication by using a user and device database, and generating the second user DApp and the key when the duplication does not occur.

In some example embodiments of the present disclosure, the method may further include: transmitting the second user DApp and the key to the blockchain, and being returned with the transaction from the blockchain; and storing the private key used for the transaction and the second user DApp in the user and the device database.

In some example embodiments of the present disclosure, the method may further include receiving a change notification of the device ownership from the blockchain by using the first user DApp, and providing the received change notification to the first user.

In some example embodiments of the present disclosure, the method may further include receiving the change notification of the device ownership from the blockchain by using the second user DApp, and providing the received change notification to the second user.

In some example embodiments of the present disclosure, the device ownership may be stored by using a DID.

### BRIEF DESCRIPTION OF THE DRAWINGS

FIG. 1 is a diagram for describing a system for delegating an ownership of a device based on a blockchain according to an example embodiment of the present disclosure.

FIGS. 2 and 3 are diagrams for describing a method for delegating an ownership of a device based on a blockchain, in particular, a device registration process according to an example embodiment of the present disclosure.

FIGS. 4 and 5 are diagrams for describing a method for delegating an ownership of a device based on a blockchain, in particular, a user registration process according to an example embodiment of the present disclosure.

FIGS. 6 and 7 are diagrams for describing a method for delegating an ownership of a device based on a blockchain, in particular, a process of transferring the ownership of the device according to an example embodiment of the present disclosure.

FIG. 8 is a block diagram for describing a computing device for implementing a method and a system for delegating an ownership of the device based on a blockchain according to an example embodiment of the present disclosure.

### DETAILED DESCRIPTION OF THE EMBODIMENTS

Hereinafter, the present disclosure will be described more fully hereinafter with reference to the accompanying drawings, in which example embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, unless explicitly described to the contrary, the word “comprise”, and variations such as “comprises” or “comprising”, will be understood to imply the inclusion of stated elements but not the exclusion of any other elements.

As used herein, “A or B”, “at least one of A and B”, “at least one of A or B”, “A, B, or C”, “at least one of A, B, and C”, and “at least one of A, B, or C” each may include any one of, or all possible combinations of, items listed together in the corresponding one of the phrases.

In addition, terms including “part’, “unit”, “module”, and the like disclosed in the specification may mean a unit that is capable of processing at least one function or operation described in this specification and this may be implemented by hardware or software or a combination of hardware and software.

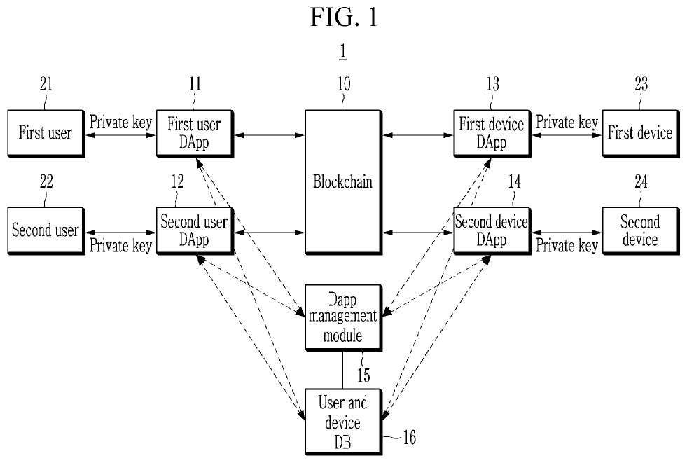

FIG. 1 is a diagram for describing a system for delegating an ownership of a device based on a blockchain according to an example embodiment of the present disclosure.

Referring to FIG. 1, the blockchain-based device ownership delegating system 1 according to an example embodiment of the present disclosure may include a blockchain 10, a user Decentralized Applications (DApps) 11 and 12, a device DApps 13 and 14, a DApp management module 15, and a user and device database (DB) 16.

The blockchain 10 records data in a block of a specific unit, and allows a plurality of nodes participating in a peer-to-peer (P2P) network to replicate and store the block, manage the block in a data structure connected in a chain form. According to such blockchain technology, integrity and security of a transaction history may be guaranteed through a consensus process in which all nodes belonging to the P2P network record and verify all transaction histories or transactions. Specifically, in the blockchain technology, the transaction history is not stored in a centralized server, but are shared by all participating nodes in the transaction, and whenever the transaction occurs, all participating nodes may contrast the shared information, so data forgery or falsification may be prevented.

The node may include a transaction history storage database and an application database. The transaction history storage database is a database that stores all lists in a correct transaction history, and the application database is a database that applies the stored transaction history to an application. The transaction history storage database may have a structure in which the blocks are connected, that is, a blockchain structure. Each of the blocks may include a list of transaction history with a set order, and the respective blocks may be connected in a time order. All transaction history orders may be determined by using such a blockchain structure.

In the P2P network, the node does not execute a specific transaction history for another node on one node, but while all nodes participating in the blockchain transaction maintain the same ledger, each node may operate by updating a database thereof by applying the transaction history. More detailed contents on the blockchain transactions may refer to documents regarding the known blockchain technology, so the description is omitted in this specification.

The DApp is referred to as a decentralized application, and means an application that may provide a specific service based on the blockchain 10, i.e., a plurality of nodes constituting the blockchain 10 without intervention of the centralized server. In particular, the DApp which is known through an Ethereum blockchain platform is a distributed application which stores a “smart contract” configured by a code by programming and enables the node constituting the blockchain 10 to execute the smart contract to reflect a transaction history by an execution result of the smart contract to the block as compared with storing only a simple transaction history in the existing blockchain platform such as Bitcoin.

The user DApps 11 and 12 may provide the service by deputizing users 21 and 22, respectively, and the users 21 and 22 may prove an ownership by digital-signing the traction with a private key in order to generate the transaction, and the digital-signed transaction may be propagated and recorded to the blockchain 10 through the user DApps 11 and 12. Similarly, the device DApps 13 and 14 may provide the device by deputizing devices 23 and 24, respectively, and the device DApps 13 and 14 and the devices 23 and 24 may send and receive digital-signed data with the private key.

The DApp management module 150 may generate and manage the user DApps 11 and 12 and the device DApps 13 and 14, and perform user registration and device registration through the DApp management module 150. The user and device database 16 may perform an operation such as storing and managing registered user or device information or storing and managing the transaction generated from the blockchain 10.

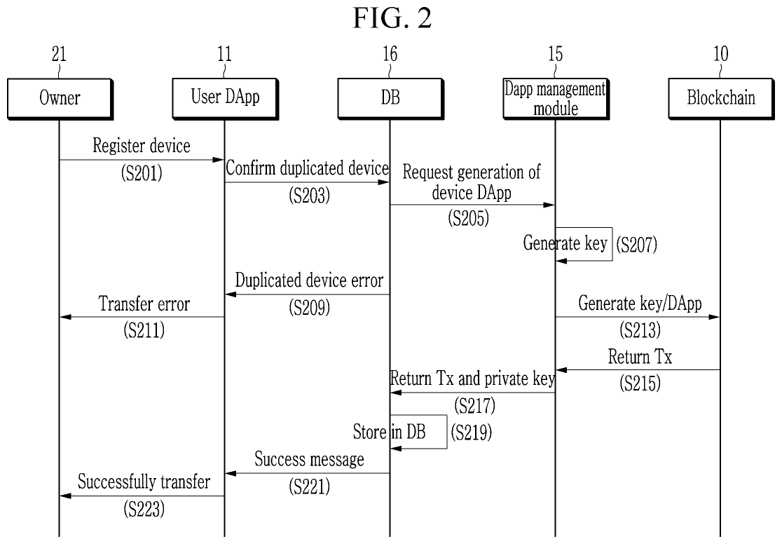

Hereinafter, referring to FIGS. 2 to 6, a blockchain-based device ownership delegating method will be described by assuming the same or similar structure as the blockchain-based device ownership delegating system 1 according to FIG. 1.

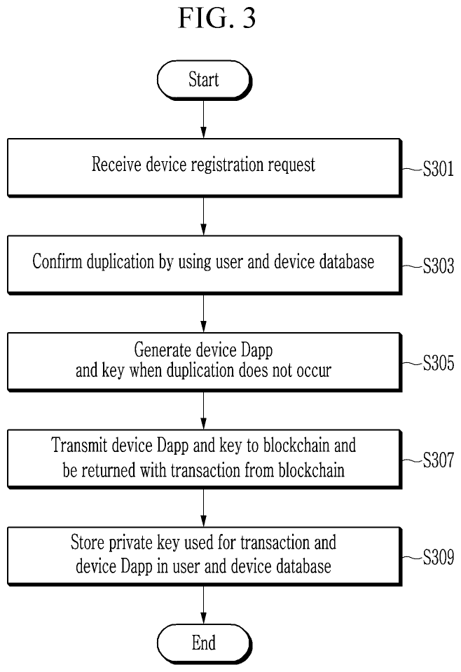

FIGS. 2 and 3 are diagrams for describing a method for delegating an ownership of a device based on a blockchain, in particular, a device registration process according to an example embodiment of the present disclosure.

Referring to FIG. 2, the blockchain-based device ownership delegating method according to an embodiment of the present disclosure may perform a device registration process of an owner.

First, an owner 21 may request device registration to the user DApp 11 (S201). Here, the owner 21 may be a device owner, and the device registration request may mean a device ownership request. The device DApp may be generated in response to the device registration request of the device owner. Specifically, a first device DApp may be generated in response to a registration request to a first device and a second device DApp may be generated in response to the registration request to a second device. Specifically, the user DApp 11 may receive a device registration request of the owner 21, and then confirm duplication by using the user and device database 16 (S203). That is, the user DApp 11 may retrieve whether effective information is already stored for the device of the owner registration-requested to the user and device database 16.

That is, the user DApp 11 may retrieve whether effective information is already stored for the device of the owner registration-requested to the user and device database 16.

In the case where the duplication does not occur, the user and device database 16 may transmit a device DApp generation request to the DApp management module 15 (S205). The DApp management module 15 may generate a key (public key) according to the device DApp generation request (S207), and then generate the device DApp which may operate by using the corresponding key.

The DApp management module 15 may transmit the device DApp and the key to the blockchain 10 (S213), and may be returned with the transaction Tx from the blockchain 10 (S215), and subsequently, the DApp management module 15 may return the private key used for the transaction and the device DApp to the user and device database 16 (S217), and as a result, the user and device database 16 may store the transaction and the private key (S219).

After the storing is completed, the user and device database 16 may transmit a success message to the user DApp 11 (S221), and subsequently, the user DApp 11 may transfer, to the owner 21, that the device registration is successfully completed (S223).

Of course, the blockchain-based device ownership delegating method (a device registration process) illustrated in FIG. 2 is example, and the detailed contents do not limit the scope of the present disclosure, and an execution subject of each operation may also be partially changed according to a specific implementation purpose.

Referring to FIG. 3, the blockchain-based device ownership delegating method according to an example embodiment of the present disclosure may include receiving a device registration request (S301), confirming duplication by using a user and device database (S303), generating a device Dapp and a key when the duplication does not occur (S305), transmitting the device DApp and the key to a blockchain and returning a transaction from the blockchain (S307), and storing a private key used for the transaction and the device DApp in the user and device database (S309).

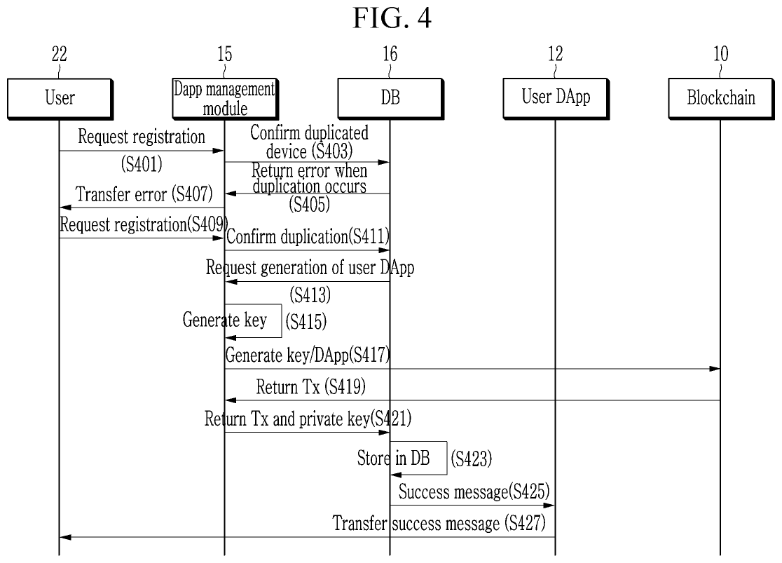

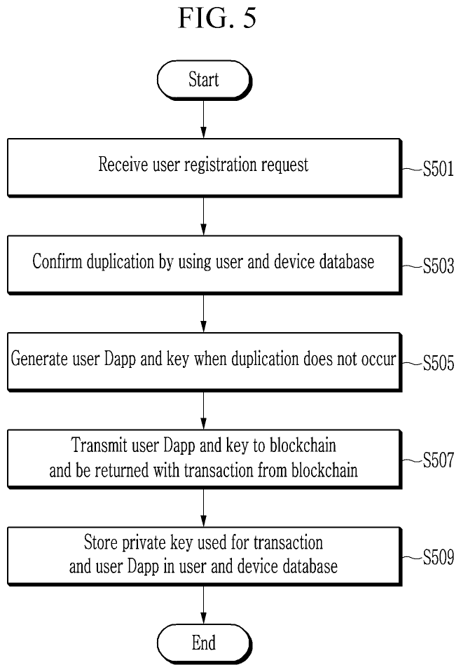

FIGS. 4 and 5 are diagrams for describing a method for delegating an ownership of a device based on a blockchain, in particular, a user registration process according to an example embodiment of the present disclosure. First, a user 22 may request user registration to a DApp management module 15 (S401)

A user DApp may be generated in response to a user registration request of the user

Specifically, a first user DApp may be generated in response to a user registration request to a first user and a second user DApp may be generated in response to the user registration request to a second user.

Specifically, the DApp management module 15 may receive the user registration request of the user 22, and then confirm duplication by using the user and device database 16 (S403). That is, the DApp management module 15 may retrieve whether effective information is already stored for the device of the user registration-requested to the user and device database 16.

In the case where the duplication occurs, the user and device database 16 may return an error to the DApp management module 15 (S405) and the DApp management module 15 may transfer the error to the user 22 (S407).

Unlike this, the user 22 requests the user registration to the DApp management module 15 (S409), and as a result of confirming the duplication by using the user and device database 16 by using the DApp management module 15 (S411), when the duplication does not occur, the user and device database 16 may transmit a user DApp generation request to the DApp management module 15 (S413). The DApp management module 15 may generate a key (public key) according to the user DApp generation request (S415), and then generate the device DApp which may operate by using the corresponding key

The DApp management module 15 may transmit a user DApp and the key to the blockchain 10 (S417), and may be returned with the transaction Tx from the blockchain 10 (S419), and subsequently, the DApp management module 15 may return the private key used for the transaction and the device DApp to the user and device database 16 (S421), and as a result, the user and device database 16 may store the transaction and the private key (S423).

After the storing is completed, the user and device database 16 may transmit a success message to the user DApp 12 (S425), and subsequently, the user DApp 12 may transfer, to the user 22, that the user registration is successfully completed (S427).

Of course, the blockchain-based device ownership delegating method (a user registration process) illustrated in FIG. 4 is example, and the detailed contents do not limit the scope of the present disclosure, and an execution subject of each operation may also be partially changed according to a specific implementation purpose.

Referring to FIG. 5, the blockchain-based device ownership delegating method according to an example embodiment of the present disclosure may include receiving a user registration request (S501), confirming duplication by using a user and device database (S503), generating a user DApp and a key when the duplication does not occur (S505), transmitting the user DApp and the key to a blockchain and returning a transaction from the blockchain (S507), and storing a private key used for the transaction and the user DApp in the user and device database (S509)

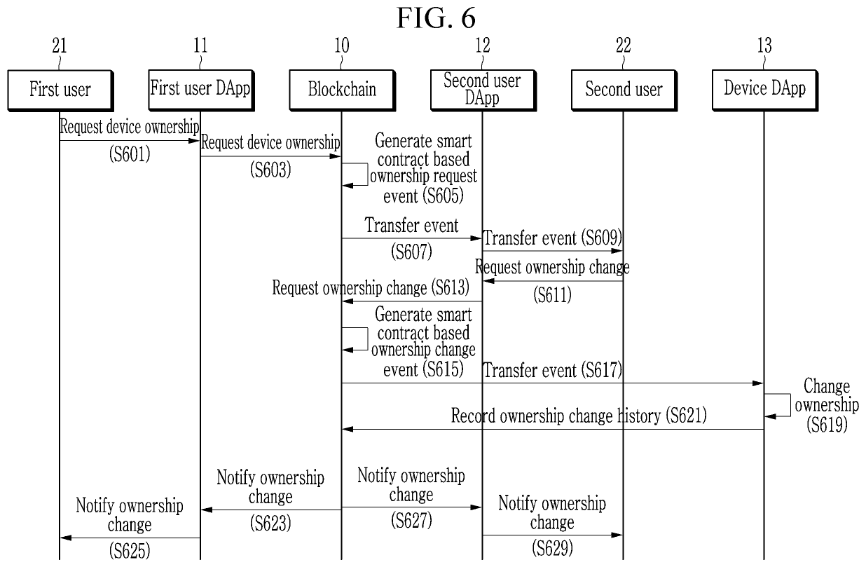

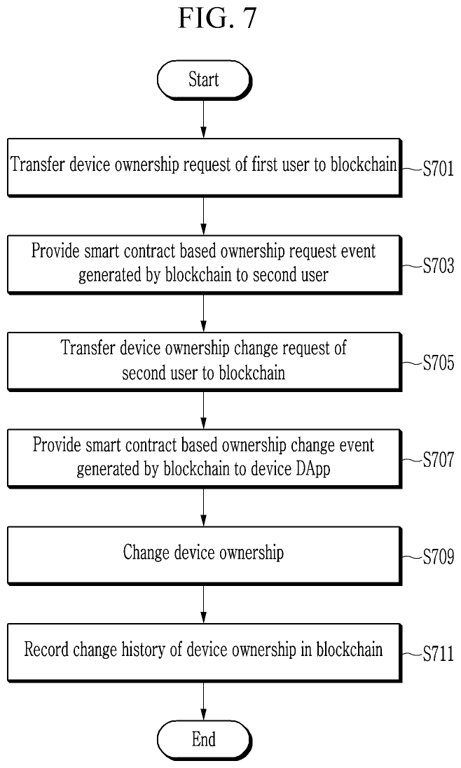

FIGS. 6 and 7 are diagrams for describing a method for delegating an ownership of a device based on a blockchain, in particular, a process of transferring the ownership of the device according to an example embodiment of the present disclosure.

Referring to FIG. 6, the blockchain-based device ownership delegating method according to an embodiment of the present disclosure may perform an ownership transfer process of a device.

First, a first user 21 may transfer a device ownership request (device registration request) to the blockchain 10. Specifically, the first user 21 may transmit the device ownership request to a first user DApp 11 (S601) and the first user DApp 11 may transmit the device ownership request received from the first user 21 to the blockchain 10 (S603).

Therefore, the blockchain 10 may generate a smart contract based ownership request event (S605). The smart contract based ownership request event generated by the blockchain 10 may be provided to a second user 22 through a second user DApp 12 (S607 and S609). Here, in the smart contract based ownership request event, a control request to a specific user or a specific terminal is generated based on a smart contract which is one of main features of the blockchain, and even a response thereto may be included.

Meanwhile, the second user 22 may transfer a device ownership change request to the blockchain 10. Specifically, the second user 22 may transmit the device ownership change request to the second user DApp 12 (S611) and the second user DApp 12 may transmit the device ownership change request received from the second user 22 to the blockchain 10 (S613).

Therefore, the blockchain 10 may generate a smart contract based ownership change event (S615). The smart contract based ownership change event generated by the blockchain 10 may be provided to the device DApp 13 (S617). Here, the smart contract based ownership change event may include temporarily changing or permanently changing the ownership of things or granting a temporary authority to things for a temporary time.

The device DApp 13 may change the ownership of the device (S619). Specifically, the device DApp 13 may change the ownership of the device from the first user to the second user. Thereafter, the device DApp 13 may record a change history of the device ownership in the blockchain 10 (S621).

Thereafter, the user DApps 11 and 22 may receive a change notification of the device ownership from the blockchain 10 and provide the change notification to the first user 21 and the second user 22. Specifically, the first user DApp 11 may receive the change notification of the device ownership from the blockchain (S623) and provide the change notification to the first user 21 (S625), and the second user DApp 12 may receive the change notification of the device ownership from the blockchain (S627) and provide the change notification to the second user 22 (S629).

Here, when both the first device 23 and the second device 24 have a blockchain function, the device ownership may be distributed and stored in the first and second devices 23 and 24 by using a decentralized identifier (DID).

Of course, the blockchain-based device ownership delegating method (a device ownership transfer process) illustrated in FIG. 6 is example, and the detailed contents do not limit the scope of the present disclosure, and an execution subject of each operation may also be partially changed according to a specific implementation purpose.

Referring to FIG. 7, the blockchain-based device ownership delegating method according to an example embodiment of the present disclosure may include transferring a device ownership request of a first user to a blockchain (S701), providing a smart contract based ownership request event generated by the blockchain to a second user (S703), transferring a device ownership change request of the second user to the blockchain (S705), providing a smart contract based ownership change event generated by the blockchain to a device DApp (S707), changing a device ownership (S709), and recording a change history of the device ownership in the blockchain (S711).

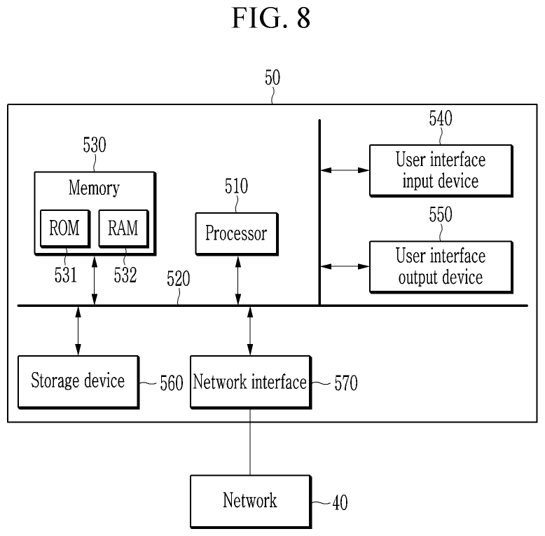

FIG. 8 is a block diagram for describing a computing device for implementing a method and a system for delegating an ownership of the device based on a blockchain according to an example embodiment of the present disclosure

Referring to FIG. 8, the method and the system for delegating a blockchain-based device ownership according to the example embodiments of the present disclosure may be implemented by using a computing device 50.

The computing device 50 may include at least one of a processor 510, a memory 530, a user interface input device 540, a user interface output device 550, and a storage device 560 which communicate through a bus 520. The computing device 50 may also include a network interface 570 electrically connected to the network 40, e.g., a wireless network. The network interface 570 may transmit/receive a signal to/from another entity through the network 40.

The processor 510 may be implemented by various types including an application processor (AP), a central processing unit (CPU), a graphic processing unit (GPU), etc., and may be any semiconductor device executing a command stored in the memory 530 or the storage device 560. The processor 510 may be configured to implement functions and methods described in FIGS. 1 to 7.

The memory 530 and the storage device 560 may be various types of volatile or non-volatile storage media. For example, the memory may include a read-only memory (ROM) 531 and a random access memory (RAM) 532. In an example embodiment of the present disclosure, the memory 530 may be positioned inside or outside the processor 510 and the memory 530 may be connected to the processor 510 though various means which is already known.

Further, the method and the system for delegating a blockchain-based device ownership according to the example embodiments of the present disclosure may be implemented by a program or software executed by the computing device 50, and the program or the software may be stored in a computer readable medium.

Further, the method and the system for delegating a blockchain-based device ownership according to the example embodiments of the present disclosure may be implemented by hardware which may be electrically connected to the computing device 50.

According to the example embodiments of the present disclosure described up to now, ownership information of a device is stored by using blockchain technology and transfer is implemented based thereon to prevent the ownership information of the device from being forged or falsified. In particular, the device ownership information is distributed and stored by using DID to avoid a single point of failure and a distributed denial of service attack.

Further, as self-sovereign identification technology is applied, personal information protection and use convenience can be significantly enhanced, and the self-sovereign identification technology can be applied to ownership transfer for digital assets in addition to ownership transfer for a physical device, and it is possible to provide various application services by utilizing smart contract technology.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

Although the example embodiment of the present disclosure has been described in detail hereinabove, the scope of the present disclosure is not limited thereto. That is, several modifications and alterations made by a person of ordinary skill in the art using a basic concept of the present disclosure as defined in the claims fall within the scope of the present disclosure.

What is claimed is:

1. A method for delegating a device ownership based on a blockchain, the method comprising:
transferring a device ownership request of a first user to a blockchain;
providing a smart contract based ownership request event generated by the blockchain to a second user;
transferring a device ownership change request of the second user to the blockchain;
providing a smart contract based ownership change event generated by the blockchain to a device decentralized application (DApp);
changing a device ownership; and
recording a change history of the device ownership in the blockchain.

2. The method of claim 1, further comprising:
generating a first user DApp according to a user registration request of the first user.

3. The method of claim 2, wherein the transferring of the device ownership request to the blockchain includes:
transmitting, to the blockchain, the device ownership request received from the first user by using the first user DApp.

4. The method of claim 1, further comprising:
generating a second user DApp according to the user registration request of the second user.

5. The method of claim 4, wherein the providing of the smart contract based ownership request event generated by the blockchain to the second user includes:
providing, to the second user, the smart contract based ownership request event received from the blockchain by using the second user DApp.

6. The method of claim 4, wherein the transferring of the device ownership change request to the blockchain includes:
transmitting, to the blockchain, the device ownership change request received from the second user by using the second user DApp.

7. The method of claim 4, wherein the second user DApp is generated in response to the user registration request of the second user.

8. The method of claim 1, wherein the device DApp is generated in response to a device registration request of a device owner.

9. The method of claim 1, further comprising:
receiving a change notification of the device ownership from the blockchain, and providing the received change notification to the first user and the second user.

10. The method of claim 1, wherein the device ownership is stored by using a decentralized identifier (DID).

11. A method for delegating a device ownership based on a blockchain, the method comprising:
generating a first user decentralized application (DApp) according to a user registration request of the first user;
generating a device DApp according to a device registration request of the first user;
transmitting, to a blockchain, the device ownership request received from the first user by using the first user DApp;
generating a second user DApp according to a user registration request of the second user;
transmitting, to the blockchain, a device ownership change request received from the second user by using the second user DApp;
changing a device ownership by using the device DApp; and
recording a change history of the device ownership in the blockchain by using the device DApp.

12. The method of claim 11, wherein the generating of the first user DApp includes:
confirming duplication by using a user and device database, and
generating the first user DApp and a key when the duplication does not occur.

13. The method of claim 12, further comprising:
transmitting the first user DApp and the key to the blockchain, and being returned with a transaction from the blockchain; and
storing a private key used for the transaction and the first user DApp in the user and the device database.

14. The method of claim 11, wherein the generating of the device DApp includes:
confirming duplication by using a user and device database, and
generating the device DApp and the key when the duplication does not occur.

15. The method of claim 14, further comprising:
transmitting the device DApp and the key to the blockchain, and being returned with the transaction from the blockchain; and
storing the private key used for the transaction and the device DApp in the user and the device database.

16. The method of claim 11, wherein the generating of the second user DApp includes:
confirming duplication by using a user and device database, and
generating the second user DApp and the key when the duplication does not occur.

17. The method of claim 16, further comprising:
transmitting the second user DApp and the key to the blockchain, and being returned with the transaction from the blockchain; and
storing the private key used for the transaction and the second user DApp in the user and the device database.

18. The method of claim 11, further comprising:
receiving a change notification of the device ownership from the blockchain by using the first user DApp, and providing the received change notification to the first user.

19. The method of claim 11, further comprising:
receiving the change notification of the device ownership from the blockchain by using the second user DApp, and providing the received change notification to the second user.

20. The method of claim 11, wherein the device ownership is stored by using a DID.
